(19) United States
(12) Patent Application Publication
(10) Pub. No.: US 2024/0246820 A1
(43) Pub. Date: Jul. 25, 2024

(54) DEVICE AND METHOD FOR ON-LINE CONTINUOUS RECOVERY OF EXCESS NITRIC ACID IN NITRATION REACTION

(71) Applicant: Fudan University, Shanghai (CN)

(72) Inventors: Fener CHEN, Shanghai (CN); Minjie LIU, Shanghai (CN); Li WAN, Shanghai (CN); Yajiao ZHANG, Shanghai (CN); Dang CHENG, Shanghai (CN)

(21) Appl. No.: 18/625,907

(22) Filed: Apr. 3, 2024

(30) Foreign Application Priority Data
Nov. 1, 2023 (CN) 202311449259.X

(51) Int. Cl. C01B 21/46; B01D 1/00; B01D 5/00

(52) U.S. Cl. CPC C01B 21/46; B01D 1/0082; B01D 5/006; B01D 5/0075

(57) ABSTRACT

A method for on-line continuous recovery of excess nitric acid in nitration reaction is provided. Nitration reaction liquid and nitrogen gas are simultaneously conveyed to a mixer, mixed and transferred to a temperature-controlled corrosion-resistant column for on-line continuous evaporation, where the nitration reaction liquid enters the temperature-controlled corrosion-resistant column from a top end, and the waste gas and excess nitric acid are discharged from a top port of the temperature-controlled corrosion-resistant column, and nitric acid is recovered. The nitric acid-free liquid is discharged from a bottom end of the temperature-controlled corrosion-resistant column by a pump.

### CROSS-REFERENCE TO RELATED APPLICATIONS

This application claims the benefit of priority from Chinese Patent Application No. 202311449259.X, filed on Nov. 1, 2023. The content of the aforementioned application, including any intervening amendments thereto, is incorporated herein by reference in its entirety.

### TECHNICAL FIELD

This application relates to organic chemical engineering technology, and more particularly to a device and method for on-line continuous recovery of excess nitric acid in nitration reaction.

### BACKGROUND

Nitration reaction is an important part in organic synthesis, and has been widely used in pharmaceutical, pesticide, and dye industries. Traditional batch nitration reaction or continuous flow nitration reaction will involve the excessive nitric acid residue, which will bring serious safety hazards in the post-treatment. Moreover, these nitration processes are often accompanied by the production of a large amount of gas waste and nitrate-containing wastewater, resulting in complicated wastewater treatment.

### SUMMARY

To overcome the deficiencies in the post-treatment of the traditional batch nitration reaction or the continuous flow nitration reaction, this application provides a device and method for on-line continuous recovery of excess nitric acid in a nitration reaction, so as to eliminate safety hazards, improve the degree of automation and efficiency, and reduce energy consumption.

Technical solutions of this application are described as follows.

In a first aspect, this application provides a device for on-line continuous recovery of nitric acid in a nitration reaction, wherein the device is an on-line continuous evaporation device and comprises:
a mixer; and
a temperature-controlled corrosion-resistant column;
wherein the mixer is configured for mixing a nitration reaction liquid delivered by a metering pump and nitrogen gas supplied by a compressed air cylinder, and feeding a nitration reaction liquid-nitrogen gas mixture into the temperature-controlled corrosion-resistant column through a first pipeline; and a flow rate of the nitrogen gas is adapted to be controlled by a gas flow meter;
the temperature-controlled corrosion-resistant column has a double-layer structure comprising an inner layer and an outer layer; the inner layer is a hollow column; a lower portion of the inner layer is filled with a mass-transfer enhancement member for dispersing the nitration reaction liquid and increasing a contact area between the nitrogen gas and the nitration reaction liquid to ensure that volatile materials are taken away by the nitrogen gas; a top end of the inner layer is connected to the mixer, and a bottom port of the inner layer is connected to a storage tank through a second pipeline; the storage tank is configured to receive a nitric acid-free reaction liquid which is produced by removing nitric acid from the nitration reaction liquid; and a pump is provided on the second pipeline to transfer the nitric acid-free reaction liquid to the storage tank;
a top port of the inner layer is connected to a condensing device through a third pipeline, such that waste gas and nitric acid are discharged from the top port of the inner layer to the condensing device through the third pipeline to allow recovery of nitric acid; and
a gap is provided between the inner layer and the outer layer, and is configured to allow a heat transfer fluid to flow through; and an upper portion of the outer layer is provided with an outlet of the heat transfer fluid, and a lower portion of the outer layer is provided with an inlet of the heat transfer fluid.

In an embodiment, the mixer has a plate-type structure with an interdigital configuration, a Caterpillar configuration or a split-and-recombine configuration.

In an embodiment, the mass-transfer enhancement member is a Z-shaped flow-disturbing plate, a horizontal corrugated plate, a vertical corrugated plate, or a 45°-inclined corrugated plate.

In an embodiment, a length of the first pipeline extending into the temperature-controlled corrosion-resistant column is ¼-½ of a length of the temperature-controlled corrosion-resistant column, so as to prevent the nitrogen gas from taking materials with a boiling point higher than the volatile materials away from the temperature-controlled corrosion-resistant column.

In an embodiment, the temperature-controlled corrosion-resistant column is made of polytetrafluoroethylene (PTFE), Hastelloy, tantalum or glass.

In a second aspect, this application provides a method for on-line continuous recovery of nitric acid in nitration reaction through the above device, comprising:
(1) feeding the nitration reaction liquid and the nitrogen gas into the mixer at the same time followed by mixing; and transporting a mixture of the nitration reaction liquid and the nitrogen gas to the temperature-controlled corrosion-resistant column for on-line continuous evaporation, wherein the nitration reaction liquid enters into the inner layer from a top end of the temperature-controlled corrosion-resistant column; and a flow rate ratio of the nitration reaction liquid to the nitrogen gas is set to 1.0:1.0-30.0, preferably 1.0:5.0-15.0;
(2) performing heat exchange through a jacket between the inner layer and the outer layer; and controlling a temperature of the heat exchange at 20-150° C. and a flow rate of the heat exchange by a temperature control machine, preferably the temperature is controlled in the range of 20-100° C.; and
(3) discharging the waste gas and the nitric acid from the top port of inner layer of the temperature-controlled corrosion-resistant column, and recovering the nitric acid through the condensing device; discharging the nitric acid-free reaction liquid from the bottom port of the inner layer of the temperature-controlled corrosion-resistant column through the pump; and storing the nitric acid-free reaction liquid for subsequent treatment.

In an embodiment, the nitration reaction liquid is prepared using a continuous flow reactor or a batch reactor.

In an embodiment, a cooling temperature of the condensing device is controlled to −20-0° C.

The on-line continuous nitric acid recovery method provided herein enables the safe and efficient treatment of the excess nitric acid in the nitration reaction process, and is suitable for industrial production.

### BRIEF DESCRIPTION OF THE DRAWINGS

FIG. 1 schematically shows a structure of an on-line nitric acid continuous recovery system according to one embodiment of the present disclosure.

### DETAILED DESCRIPTION OF EMBODIMENTS

The disclosure is further described below in conjunction with the embodiments and the accompanying drawings.

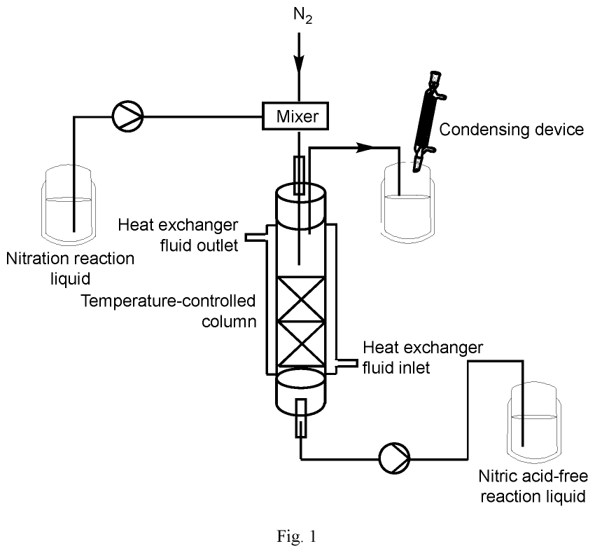

The on-line continuous nitric acid recovery system used in the embodiments is structurally shown in FIG. 1, and is operated as follows.

A metering pump is used to quantitatively deliver nitration reaction liquid. A compressed air cylinder supplies nitrogen gas, and a flow rate of the nitrogen gas is adapted to be controlled by a gas flow meter. The nitration reaction liquid and the nitrogen gas are pre-mixed to obtain a mixture of nitration reaction liquid and nitrogen gas in a mixer, then the mixture enters a temperature-controlled corrosion-resistant column through a pipeline. The length of a pipeline extending into the temperature-controlled corrosion-resistant column is ¼-½ of the length of the temperature-controlled corrosion-resistant column, so as to prevent the nitrogen gas from taking the high-boiling point materials away from the temperature-controlled corrosion-resistant column. The nitration reaction liquid and the nitrogen gas are mass-transferred and strengthened on a mass-transfer enhancement member, which increases the gas-liquid contact area between the nitrogen gas and the nitration reaction liquid and disperses the nitration reaction liquid into finer droplets to accelerate the volatilization of nitric acid. At the same time, the temperature and flow rate of the heat transfer fluid are controlled to heat the temperature-controlled corrosion-resistant column and accelerate the volatilization of nitric acid. The vaporized nitric acid and the waste gas are discharged from a top outlet of the temperature-controlled corrosion-resistant column into a collection tank with a condensing device to condense and recover the nitric acid. The nitric acid-free reaction liquid is transferred from a bottom end of the temperature-controlled corrosion-resistant column by a pump into a storage tank for subsequent treatment or into the recycling set to increase the product concentration in the reaction solution.

### EXAMPLE 1

A metering pump controlled a flow rate of nitration reaction liquid of benzene. A gas flow meter controlled a flow rate of nitrogen gas. The nitration reaction liquid and the nitrogen gas at the same time were transported to the mixer followed by mixing, then entered a top end of a temperature-controlled glass column. The temperature of the temperature-controlled glass column was controlled to 20° C. The flow rate ratio of the nitration reaction liquid to the nitrogen gas was controlled to 1.0:6.0. The waste gas and the excess nitric acid were exhausted from a top outlet of the temperature-controlled glass column and entered the condensing device of −15° C. to recycle the nitric acid. After removing the nitric acid, the residual liquid was discharged from the bottom port of the temperature-controlled glass column by a pump. The nitric acid content in the residual liquid was measured to be 0.1% by redox titration. The obtained nitric acid-free nitrification liquid was used for subsequent treatment or the recycling set.

### EXAMPLE 2

A metering pump controlled a flow rate of nitration reaction liquid of toluene. A gas flow meter controlled a flow rate of nitrogen gas. The nitration reaction liquid and the nitrogen gas at the same time were transported to the mixer followed by mixing, then entered a top end of a temperature-controlled Hastelloy column. The temperature of the temperature-controlled Hastelloy column was controlled to 30° C. The flow rate ratio of the nitration reaction liquid to the nitrogen gas was controlled to 1.0:8.0. The waste gas and the excess nitric acid were exhausted from a top outlet of the temperature-controlled Hastelloy column and entered the condensing device of −10° C. to recycle the nitric acid. After removing the nitric acid, the residual liquid was discharged from the bottom port of the temperature-controlled Hastelloy column by a pump. The nitric acid content in the residual liquid was measured to be 0.08% by redox titration. The obtained nitric acid-free nitrification liquid was used for subsequent treatment or the recycling set.

### EXAMPLE 3

A metering pump controlled a flow rate of nitration reaction liquid of 2-methylimidazole. A gas flow meter controlled a flow rate of nitrogen gas. The nitration reaction liquid and the nitrogen gas at the same time were transported to the mixer followed by mixing, then entered the top end of the temperature-controlled glass column. The temperature of the temperature-controlled glass column was controlled to 80° C. The flow rate ratio of the nitration reaction liquid to the nitrogen gas was controlled to 1.0:10.0. The waste gas and the excess nitric acid were exhausted from a top outlet of the temperature-controlled glass column and entered the condensing device of −15° C. to recycle the nitric acid. After removing the nitric acid, the residual liquid was discharged from the bottom port of the temperature-controlled glass column by a pump. The nitric acid content in the residual liquid was measured to be 0.01% by redox titration. The obtained nitric acid-free nitrification liquid was used for subsequent treatment or the recycling set.

### EXAMPLE 4

A metering pump controlled a flow rate of nitration reaction liquid of chlorobenzene. A gas flow meter controlled a flow rate of nitrogen gas. The nitration reaction liquid and the nitrogen gas at the same time were transported to the mixer followed by mixing, then entered the top end of the temperature-controlled tantalum column. The temperature of the temperature-controlled tantalum column was controlled to 100° C. The flow rate ratio of the nitration reaction liquid to the nitrogen gas was controlled to 1.0:15.0. The waste gas and the excess nitric acid were exhausted from a top outlet of the temperature-controlled tantalum column and entered the condensing device of −10° C. to recycle the nitric acid. After removing the nitric acid, the residual liquid was discharged from the bottom port of the temperature-controlled tantalum column by a pump. The nitric acid content in the residual liquid was measured to be 0.03% by redox titration. The resultant nitric acid-free nitrification liquid was used for subsequent treatment or recycled.

What is claimed is:

1. A device for on-line continuous recovery of nitric acid in a nitration reaction, the device being an on-line continuous evaporation device and comprising:
a mixer; and
a temperature-controlled corrosion-resistant column;
wherein the mixer is configured for mixing a nitration reaction liquid delivered by a metering pump and nitrogen gas supplied by a compressed air cylinder, and feeding a nitration reaction liquid-nitrogen gas mixture into the temperature-controlled corrosion-resistant column through a first pipeline; and a flow rate of the nitrogen gas is adapted to be controlled by a gas flow meter;
the temperature-controlled corrosion-resistant column has a double-layer structure comprising an inner layer and an outer layer; the inner layer is a hollow column; a lower portion of the inner layer is filled with a mass-transfer enhancement member for dispersing the nitration reaction liquid and increasing a contact area between the nitrogen gas and the nitration reaction liquid to ensure that volatile materials are taken away by the nitrogen gas; a top end of the inner layer is connected to the mixer, and a bottom port of the inner layer is connected to a storage tank through a second pipeline; the storage tank is configured to receive a nitric acid-free reaction liquid which is produced by removing nitric acid from the nitration reaction liquid; and a pump is provided on the second pipeline to transfer the nitric acid-free reaction liquid to the storage tank;
a top port of the inner layer is connected to a condensing device through a third pipeline, such that waste gas and nitric acid are discharged from the top port of the inner layer to the condensing device through the third pipeline to allow recovery of nitric acid; and
a gap is provided between the inner layer and the outer layer, and is configured to allow a heat transfer fluid to flow through; and an upper portion of the outer layer is provided with an outlet of the heat transfer fluid, and a lower portion of the outer layer is provided with an inlet of the heat transfer fluid.

2. The device of claim 1, wherein the mixer has a plate-type structure with an interdigital configuration, a Caterpillar configuration or a split-and-recombine configuration.

3. The device of claim 1, wherein the mass-transfer enhancement member is a Z-shaped flow-disturbing plate, a horizontal corrugated plate, a vertical corrugated plate, or a 45°-inclined corrugated plate.

4. The device of claim 1, wherein a length of the first pipeline extending into the temperature-controlled corrosion-resistant column is ¼-½ of a length of the temperature-controlled corrosion-resistant column, so as to prevent the nitrogen gas from taking materials with a boiling point higher than the volatile materials away from the temperature-controlled corrosion-resistant column.

5. The device of claim 1, wherein the temperature-controlled corrosion-resistant column is made of polytetrafluoroethylene (PTFE), Hastelloy, tantalum or glass.

6. A method for on-line continuous recovery of nitric acid in nitration reaction through the device of claim 1, comprising:
(1) feeding the nitration reaction liquid and the nitrogen gas into the mixer at the same time followed by mixing; and transporting a mixture of the nitration reaction liquid and the nitrogen gas to the temperature-controlled corrosion-resistant column for on-line continuous evaporation, wherein the nitration reaction liquid enters into the inner layer from a top end of the temperature-controlled corrosion-resistant column; and a flow rate ratio of the nitration reaction liquid to the nitrogen gas is set to 1.0:1.0-30.0;
(2) performing heat exchange through a jacket between the inner layer and the outer layer; and controlling a temperature of the heat exchange at 20-150° C. and a flow rate of the heat exchange by a temperature control machine; and
(3) discharging the waste gas and the nitric acid from the top port of inner layer of the temperature-controlled corrosion-resistant column, and recovering the nitric acid through the condensing device; discharging the nitric acid-free reaction liquid from the bottom port of the inner layer of the temperature-controlled corrosion-resistant column through the pump; and storing the nitric acid-free reaction liquid for subsequent treatment.

7. The method of claim 6, wherein the nitration reaction liquid is prepared using a continuous flow reactor or a batch reactor.

8. The method of claim 6, wherein a cooling temperature of the condensing device is controlled to −20-0° C.
